(19) United States
(12) Patent Application Publication
(10) Pub. No.: US 2024/0408929 A1
(43) Pub. Date: Dec. 12, 2024

(54) LOSS OF A SUBSYSTEM AND INTERACTIONS WITH EXTERNAL SYSTEMS

(71) Applicant: JAGUAR LAND ROVER LIMITED, Warwickshire (GB)

(72) Inventors: Adrian Bouaru, Whitley, Coventry, Warwickshire (GB); Alexander Wojtecki, Whitley, Coventry, Warwickshire (GB)

(21) Appl. No.: 18/702,455

(22) PCT Filed: Oct. 18, 2021
(86) PCT No.: PCT/EP2021/078809

§ 371 Date: Apr. 18, 2024

(51) Int. Cl. B60G 17/0185; B60W 30/04; B60W 40/10

(52) U.S. Cl. CPC B60G 17/0185; B60W 30/04; B60W 40/10; B60G 2600/08

(57) ABSTRACT

Aspects of the present invention relate to a control system (100, 200) for a vehicle suspension system of a vehicle. The vehicle suspension system comprises a plurality of connected subsystems (302, 304, 306). The control system comprises one or more controllers (110). The control system is configured to: determine if a first subsystem (302) of the plurality of connected subsystems has entered a fault state (312-2), wherein the fault state is an abnormal operating state (402); determine a compensatory operating state (314-2, 316-2) of a further subsystem of the plurality of electrically connected subsystems, in dependence on determining that the first subsystem has entered the fault state, wherein the further subsystem operating in the compensatory operating state, with the first subsystem operating in the fault state, causes the vehicle suspension system to operate in a higher vehicle stability mode in comparison to the vehicle suspension system operating with the first subsystem operating in the fault state without the further subsystem operating in the compensatory operating state (404); and output, to the further subsystem, in dependence on determining the compensatory operating state, a compensatory operation signal (155) to cause the further subsystem to operate in the compensatory operating state with the first subsystem operating in the fault state (406).

### TECHNICAL FIELD

The present disclosure relates interactions between subsystems within a vehicle when normal function of a subsystem is lost. Aspects relate to a control system to a system, to a vehicle, to a method, and to computer software.

### BACKGROUND

Vehicles, (for example electric, hybrid, petrol or diesel vehicles) may comprise active suspension systems, such as active roll control subsystems, active springs subsystems, and semi-active damping subsystems, for maintaining vehicle stability and driving attributes at a user level.

However, in some scenarios one or more of the subsystems may enter an issue such as a fault state. For example, the subsystem may not operate and perform as expected, as a result of the particular subsystem entering a fault state. For such a scenario, in conventional control systems within a vehicle, fault reaction strategies may be used. However, such fault reaction strategies are fixed and are non-adaptive. That is, the fixed strategies provide a fixed set of reactions in response to a given failure. For example, whenever subsystem A suffers a particular failure, subsystem B out of a plurality of subsystems always reacts in the same way. As such, fault reaction strategies of conventional control systems do not take into account any use case of the vehicle or circumstances of the fault. Therefore, the result of current fault reaction strategies may not be the most appropriate and may cause inappropriate changes, such as unnecessary and excessive degradation to a vehicle attribute or attributes, along with exposing components within the other subsystems to potential damage.

Therefore, there is a need for a control system within a suspension system of a vehicle whereby fault responses from subsystems are made adaptively and appropriately for a vehicle use case. It is an aim of examples disclosed herein to address one or more of the disadvantages associated with the prior art.

### SUMMARY OF THE INVENTION

Aspects and embodiments of the invention disclosed herein provide a control system, to a system, to a vehicle, to a method, and computer software, as claimed in the appended claims.

According to an aspect of the present invention there is provided a control system for a vehicle suspension system in a vehicle, the vehicle suspension system comprising a plurality of connected subsystems, the control system comprising one or more controllers, the control system configured to: determine if a first subsystem of the plurality of connected subsystems has entered a fault state, wherein the fault state is an abnormal operating state; determine a compensatory operating state of a further subsystem of the plurality of connected subsystems in dependence on determining that the first subsystem has entered the fault state, wherein the further subsystem operating in the compensatory operating state, with the first subsystem operating in the fault state, causes the vehicle suspension system to operate in a higher vehicle stability mode in comparison to the vehicle suspension system operating with the first subsystem operating in the fault state without the further subsystem operating in the compensatory operating state; and output, to the further subsystem, in dependence on determining the compensatory operating state, a compensatory operation signal to cause the further subsystem to operate in the compensatory operating state with the first subsystem operating in the fault state.

An abnormal operating state may be thought of as a state of operation other than the desired normal operating state—for example, full functionality may not be available, or the subsystem may be operating outside preferred operating parameters such as a preferred temperature or voltage range. In the fault state, it may be that the subsystem is not operating in the desired normal operating state, due to one or more of the components within the subsystem themselves entering a fault state. Causing the vehicle suspension system to operate in a higher vehicle stability mode may be considered to comprise causing the vehicle suspension system to provide the same or an improved level of vehicle stability without incurring a level of vehicle level attribute degradation as would be suffered in the case of the vehicle suspension system operating with the first subsystem operating in the fault state without the further subsystem operating in the compensatory operating state. The plurality of subsystems may be variously electrically and/or mechanically connected.

The control system may be further configured to, in dependence on determining that the first subsystem has entered the fault state: output, to the first subsystem, a limited state request to cause the first subsystem to operate in a limited state, wherein the limited state is a limited functionality operating state (i.e. limited in relation to the full capability of the subsystem). For example, the maximum allowable torque demand to the suspension system may be limited, or the maximum electronic active roll control system actuator motor speed may be limited, as a limited functionality operating state.

The compensatory operation signal may comprise a request to the further subsystem to change at least one subsystem operating parameter of the further subsystem in dependence on a determined vehicle condition to cause the further subsystem to operate in the determined compensatory operating state.

The control system may be further configured to determine the compensatory operating state by identifying the at least one subsystem operating parameter in a look-up matrix; wherein the look-up matrix indicates, for at least one fault state of the primary subsystem, a compensatory value for the at least one subsystem operating parameter for provision to the further subsystem to cause the further subsystem to operate in the compensatory operating state in dependence on the vehicle condition. The look-up matrix may be configured to be any non-linear mapping function.

The vehicle condition may comprise at least one of: a determined driving condition, indicative of a current interaction between the vehicle and a driving surface; a user-set driving mode, indicative of one or more subsystem operating parameter to be prioritised; and an operating limit setting, indicative of a limit value of the one or more subsystem operating parameters. The limit value may be a maximum value indicating the upper boundary of an allowed operating window of values, or a minimum value indicating the lower boundary of the allowed operating window of values.

The control system may be further configured to: periodically receive a second vehicle condition; compare the vehicle condition to the second vehicle condition; in response to the vehicle condition being different to the second vehicle condition, determine a second compensatory operating state in dependence on the second vehicle condition; and output, to the further subsystem, a second compensatory operation signal to cause the further subsystem to operate in the second compensatory operating state with the first subsystem operating in the fault state.

The control system may be further configured to, when determining the driving condition: receive at least one detected signal, from at least one sensor of the vehicle; and input the received detected signal into a model to determine the driving condition, wherein the determined driving condition is at least one of whether the vehicle is performing a braking manoeuvre; whether the vehicle is performing an accelerating manoeuvre; whether the vehicle is moving at substantially constant speed; and whether the vehicle is performing a cornering manoeuvre.

The higher vehicle stability mode may be one or more of: an operation mode of the vehicle suspension system configured to reduce the magnitude of impacts/loads on one or more other systems within the vehicle; an operation mode configured to maintain a current driving attribute of the vehicle; and an operation mode configured to limit (for example restrict) operational regions of the vehicle.

The control system may be further configured to cause the further subsystem to operate in a compensatory operating state by causing the further subsystem to gradually operate in the compensatory operating state over a period of time.

The control system may be further configured to maintain the fault state of the first subsystem and the compensatory operating state of the further subsystem until the vehicle performs a power-down process.

The control system may be further configured to: determine that the first subsystem has completed operating in the fault state in response to a subsystem operating parameter of the first subsystem being within a predetermined operating parameter range; and in dependence on determining that the first subsystem has completed operating in the fault state, output a normal operation indicator to the further subsystem, wherein the normal operation indicator is configured to cause the further subsystem to operate in the operating mode it was operating in prior to operating in the fault state.

The control system may be further configured to determine that the first subsystem is operating in a fault state by receiving a fault indicator from the first subsystem, the fault indicator indicating that at least one component of the first subsystem has entered the fault state.

The one or more of the first subsystem and the further subsystem may be one or more of: an active roll control system of the vehicle suspension system; an active damping system of the vehicle suspension system; an active springs system of the vehicle suspension system; a roll stability control system of the vehicle suspension system; a fully active suspension system; a directional stability control system; a rear wheel steering system; and an air suspension system.

In another aspect there is provided a vehicle comprising any control system disclosed herein.

In another aspect there is provided a system comprising: a control system disclosed herein and a plurality of connected subsystems. Sets of subsystems in the plurality of subsystems may be variously connected mechanically, electrically, or electromechanically/mechatronically.

In another aspect there is provided a method, comprising: determining if a first subsystem of a plurality of connected subsystems of a vehicle suspension system has entered a fault state, wherein the fault state is an abnormal operating state; in dependence on determining that the first subsystem has entered the fault state, determining a compensatory operating state of a further subsystem of the plurality of connected subsystems, wherein the further subsystem operating in the compensatory operating state, with the first subsystem operating in the fault state, causes the vehicle suspension system to operate in a high vehicle stability mode in comparison to the vehicle suspension system operating with the first subsystem operating in the fault state without the further subsystem operating in the compensatory operating state; and outputting, to the further subsystem, a compensatory operation signal to cause the further subsystem to operate in the compensatory operating state with the first subsystem operating in the fault state.

In a further aspect there is provided computer readable instructions which, when executed by a processor of any control system disclosed herein, are arranged to perform any method disclosed herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a controller of a control system according to examples disclosed herein;

FIG. 2a shows a controller and actuator set of a control system for a vehicle suspension system according to examples disclosed herein;

FIG. 2b shows a control system for a vehicle suspension system according to examples disclosed herein;

FIG. 2c shows a control system for a vehicle suspension system according to examples disclosed herein;

FIG. 3 shows interactions between subsystems according to examples disclosed herein;

FIG. 4 shows a method according to examples disclosed herein; and

FIG. 5 shows a vehicle according to examples disclosed herein.

### DETAILED DESCRIPTION

Examples discussed herein provide a control system for a suspension system for use, for example, in the automotive industry.

Active suspensions systems, utilise mechatronic systems which may include a cascade of;
(a) a high level vehicle control generating a system demand signal (for example torque demand) to influence vehicle motion;
(b) a low level controller providing control signals to the actuator (motor control etc) to deliver the demanded signal from the high level control;
(c) motor and associated mechanical components to deliver the physical manifestation of the demanded signal; and
(d) a dedicated power supply system that delivers or recovers energy during transient and steady state demands.

The component from (b) will usually collect data from the physical actuation layer (c), which may be in the form of motor temperature and motor position displacement. These measurements will be taken during normal module operation and will be made available to the high level vehicle control strategy via an automotive communication bus. The suspension system has a high functional safety integrity requirement. The individual subsystems comprising the system (a, b, c, d) may have lower standalone capability in terms of the safety level they can achieve. The main hazard associated with the operation of the suspension system is unintended actuation, which can lead to vehicle path deviation and risk of serious injury or death. If one component from the suspension system fails (i.e. transitions into a fault state), the entire system may be disabled. Loss of suspension subsystems may results in significant loss of stability at vehicle level, especially during transient manoeuvres.

Other systems fitted on the vehicle may respond to the subsystem loss to ensure the vehicle is in a safe state. The transition to an acceptable vehicle state can be achieved through a variety of actions. Examples disclosed herein may address such issues, including through consideration of interactions between a faulty subsystem and any other systems which may help enhance the stability of the vehicle, in the situation where loss of the faulty subsystem occurs.

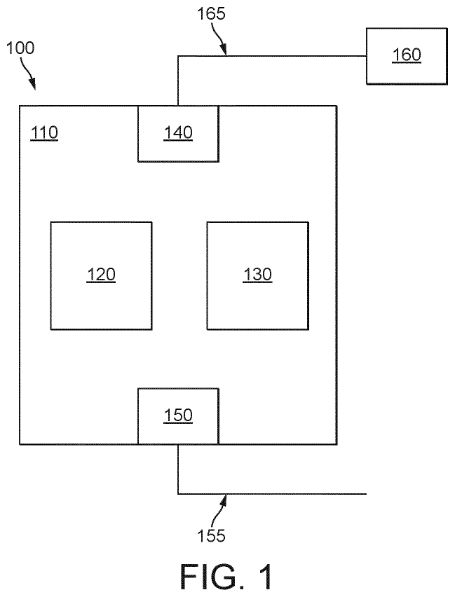

With reference to FIG. 1, there is illustrated a control system 100 for a vehicle. The control system 100 as illustrated in FIG. 1 comprises one controller 110, although it will be appreciated that this is merely illustrative and in other examples the control system 100 may comprise more than one controller 110. The controller 110 comprises processing means 120 and memory means 130. The processing means 120 may be one or more electronic processing device 120 which operably executes computer-readable instructions. The memory means 130 may be one or more memory device 130. The memory means 130 is electrically coupled to the processing means 120. The memory means 130 is configured to store instructions, and the processing means 120 is configured to access the memory means 130 and execute the instructions stored thereon.

The controller 110 comprises an input means 140 and an output means 150. The input means 140 may comprise an electrical input of the controller 110. The output means may comprise an electrical input 150 of the controller 110. The input 140 is arranged to receive one or more input signals 165, for example from a sensor 160. There may be one or more sensors which provide information to the controller input 140. The output 150 is configured to provide one or more output signals 155.

In an example, the control system 100 may be for a vehicle suspension system of a vehicle. The vehicle suspension system may comprise a plurality of connected subsystems. The control system 100 may comprise one or more controllers 110. The control system 100 may be configured to determine if a first subsystem of the plurality of connected subsystems has entered a fault state. The fault state is an abnormal operating state. For example, the control system 100 may determine that the first subsystem no longer outputs the correct amount of torque, in response to a torque demand signal. That is, the fault state may be an operating state in which the subsystem is not able to deliver a primary function due to a fault being active in the subsystem. That is, the fault state may prevent the subsystem from operating in a normal operating state.

The control system 100 may be configured to determine a compensatory operating state of a further subsystem of the plurality of connected subsystems, in dependence on determining that the first subsystem has entered the fault state. The further subsystem may then operate in the compensatory operating state, with the first subsystem operating in the fault state. Doing so may cause the vehicle suspension system to operate in a higher vehicle stability mode in comparison to the vehicle suspension system operating with the first subsystem operating in the fault state without the further subsystem operating in the compensatory operating state. That is, the vehicle suspension system may be able to deliver either the same of an improved level of vehicle stability in comparison with a vehicle suspensions system having a first subsystem operating in a fault state without the further subsystem reacting and operating in a compensatory operating state.

The control system 100 may be configured to, in dependence on determining the compensatory operating state, output, to the further subsystem, a compensatory operation signal as an output 155 to cause the further subsystem to operate in the compensatory operating state with the first subsystem operating in the fault state. In some examples, the control system 100 may be configured to determine that the first subsystem is operating in the fault state by receiving a fault indicator as an input signal 165 from the first subsystem. The fault indicator may be configured to indicate, to the control system 100, that at least one component of the first subsystem has entered the fault state. In some examples, the first subsystem may output the fault indicator to further subsystems within the plurality of subsystems. That is, once a subsystem enters a fault state, further subsystems are notified, via the fault indicator, to become aware that the first subsystem is in the fault state and can therefore no longer perform an assigned role in the same way. For example, an electronic active roll control subsystem may no longer provide roll control when entering a fault state.

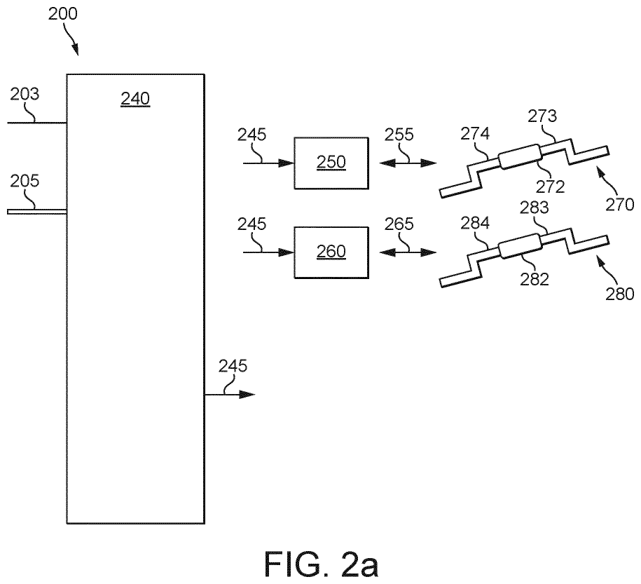

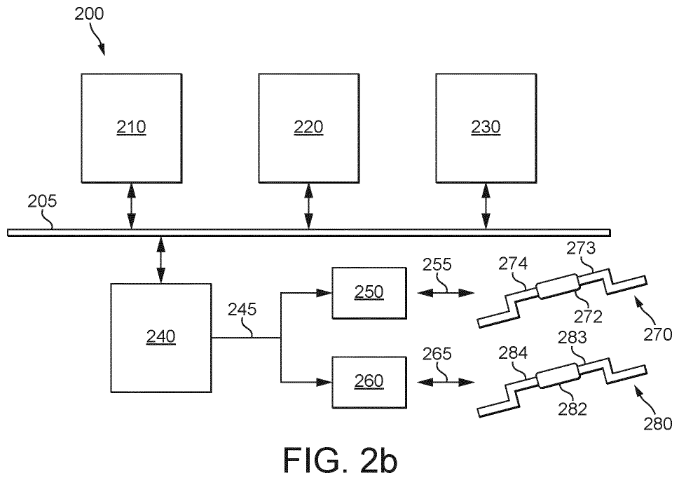

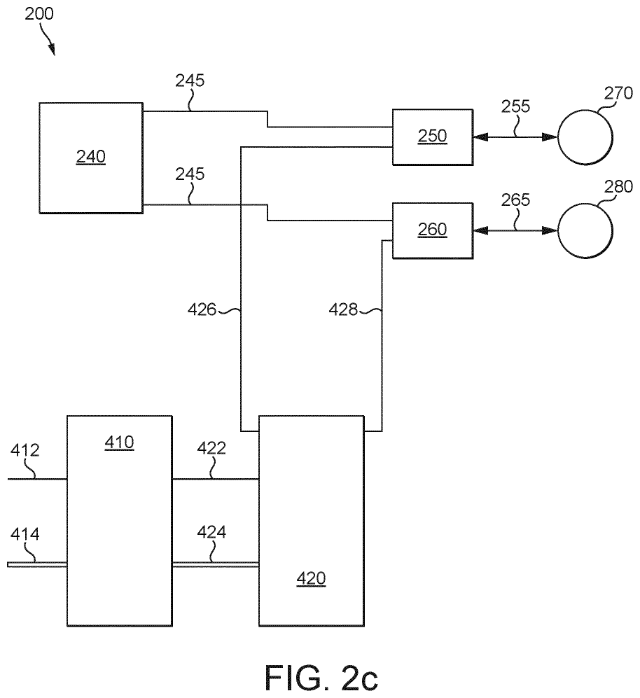

FIGS. 2a and 2b illustrate example control system for a suspension system of a vehicle. A suspension system of a vehicle may comprise anti-roll bars which are controlled using an anti-roll control system. The anti-roll control system acts to control the anti-roll bars, to control a roll of a body of the vehicle and reduce the impact of disturbances from a road surface. The anti-roll control system may be electromechanical and/or hydraulic. Anti-roll bars may typically comprise stabiliser bars, typically metal, which join the vehicle suspension on either side of the vehicle axle, usually through drop links, and connect to a rotational actuator situated between the mounting points to the vehicle chassis Each side of the anti-roll bar is able to rotate freely when a motor of the anti-roll control system is not energised. When the motor control is enabled (i.e., delivering torque), the anti-roll bar may act as a torsional spring. The anti-roll bars may be controlled to compensate for some vehicle movements such as body roll, for example from driving around a corner. Body roll can cause the wheels at the side of the vehicle outside the turn to reduce their contact with the road surface. Anti-roll bars may be controlled to counteract this effect and reduce the body roll effect, by transferring at least part of the additional load on the wheels at the side of the vehicle inside the turn to those wheels at the outside, for example by providing a torsional effect to pull the wheels towards the chassis and even out the imbalance in load on the wheels caused by cornering.

A typical suspension system may comprise passive front and rear anti-roll bars provided respectively between the front and rear pairs of wheels of a standard four-wheel vehicle. In a vehicle with an active roll control system, an anti-roll bar may respectively comprise two anti-roll bar ends 273, 274; 283, 284 connected together by a central housing having an actuator 272, 282. The central housing may additionally have one or more of a gearbox, sensors, and dedicated actuator controllers. The actuator 272, 282 acts to provide an actively controlled torque rather than a fixed torsional stiffness provided by passive anti-roll bars. One or more sensors may monitor the movement of the vehicle, and provide the sensed parameters as input to the active roll control system to control the actuator and provide a suitable torque to the anti-roll bar. The two ends of the anti-roll bar 273, 274; 283, 284 may be identical, or may be non-identical.

FIG. 2a shows an example control system 200 for a suspension system a vehicle, communicatively connected to front and rear anti-roll bars 270, 280. The control system 200 comprises a controller 240 which is connected by a bidirectional communication channel 245 to anti-roll bar controllers 250, 260 configured to respectively control front and rear anti-roll actuators 270, 280. The controller 240 may be the controller 110 of FIG. 1. The controller 240 may comprise one or more of the controllers 110 of FIG. 1. In an example, the controller 240 may be a master controller for an electronic active roll control system in the vehicle. The controller 240 may host a vehicle level control strategy and actuation control for the electronic active roll control system in the vehicle.

The controller 240 may be configured to receive one or more sensor signal 203 from one or more sensors attached to the vehicle. The one or more sensor signal 203 may comprise, for example: a signal from a respective suspension height sensor of the vehicle suspension; a signal from a respective hub acceleration sensor of the vehicle; and a signal from a respective torque demand sensor for the anti-roll bar actuators 272, 282. A signal from a respective motor position sensor for the anti-roll bar actuators 272, 282 may be communicated to the controller 240 via the communication link 245. The respective suspension height sensor may be configured to determine a sensor signal indicative of one or more of a height of a left side and a height of a right side (for example at the individual wheels) of the vehicle suspension. The respective motor position sensor may be configured to determine a sensor signal indicative of a position of a respective motor of the anti-roll bar actuators 272, 282. The respective hub acceleration sensor may be configured to determine a sensor signal indicative of an acceleration of one or more hub of a wheel of the vehicle. The torque sensor may provide a measure of an existing torque generated in the system, as a result of a target torque demand being requested by the controller 240.

The controller 240 may be configured to receive one or more communication signal via a communications bus 205. The communications bus 205 may be configured to deliver data to the controller 240 from other subsystems within the vehicle. For example, the communications bus 205 may be configured to communicate a signal indicating a status of one or more modules 210, 220, 230 that are in communicative connection with the controller 240 to the controller 240. In another example, the communications bus 205 may be configured to communicate a command from the controller 240 to the one or more modules 210, 220, 230 that are in communicative connection with the controller 240. The one or more modules 210, 220, 230, are discussed further in relation to FIG. 2b below. Signals transmitted over connections 203 or 245 may alternatively or additionally be transmitted over communications bus 205.

The controller 240 may be configured to generate system demand signals to influence a vehicle's motion via the anti-roll actuators 272, 282. An actuator provided between a front pair of wheels of a vehicle may be called a front actuator. A front active roll control (FARC) module may be electrically connected to the front actuator, and may comprise the controller 250 to control the front actuator 270. Similarly, an actuator provided between a rear pair of wheels of a vehicle may be called a rear actuator. A rear active roll control (RARC) module may be electrically connected to the rear actuator and may comprise a controller 260 to control the rear actuator 280.

The front and rear anti-roll actuators 272, 282 comprises an electric motor which is controllable by the respective anti-roll controller 250, 260. Each of the front and rear anti-roll actuators 272, 282 may be controlled by its own respective anti-roll controller in some examples, or multiple anti-roll actuators may be controlled by a common anti-roll controller in some examples. Each of the anti-roll actuators 272, 282 may be individually controlled in some cases to improve the management of the roll of the body of the vehicle. The front and rear anti-roll actuators 272, 282 may be controlled by a control signal which is generated by the controller 240. The controller may generate and output this control signal through the output channel 245, to the anti-roll bar controllers 250, 260, which then use the communication channel 245 to exchange data with the controller 240. The control signal may carry instructions to be implemented by the actuator, for example by providing a torque via a torque demand to apply to the anti-roll bar. For example, as discussed above, when the vehicle is cornering, a control signal may be transmitted to the anti-roll bar controllers 250, 260, which may in turn transmit a control signal via the interface 255, 265, so that the front and rear anti-roll actuators 272, 282 may mitigate a body roll effect. Similarly, anti-roll bar controllers 250, 260 may transmit measured values from the anti-roll actuators to the controller 240 through output channel 245.

FIG. 2b shows an example control system 200 for a vehicle comprising one or more modules 210, 220, 230, a controller 240 and front and rear anti-roll bars 270, 280. As in FIG. 2a, the control system 200 comprises a controller 240 which is connected by a bidirectional communication channel 245 to controllers 250, 260 configured to respectively control front and rear anti-roll bar actuators 270, 280. Further, the controller 240 of the control system 200 is in a communicative connection to the one or more modules 210, 220, 230 via a communications bus 205. The one or more modules 210, 220, 230 may be configured to perform functions relating to power supply of the suspension system. Module 210 may be a power control module configured to control to a power supply system for the suspension system. Module 220 may be a conversion module configured to convert electrical energy output from the vehicle power supply system. In an example, the conversion module 220 may be a DC-DC converter. Module 230 may be a capacitor module configured to store electrical energy for the suspension system. In an example, the capacitor module 230 may comprise one or more of a capacitor, a super capacitor, and a battery configured to stored electrical energy from the power supply system for the suspension system. Together, conversion module 220 and capacitor module 230 may be configured to supply electrical energy to the controllers 250, 260, such that the anti-roll bar actuators 272, 282 can be actuated. FIG. 2b illustrating modules 210, 220, 230 as individual modules. However, there may be examples whereby components within the modules 210, 220, and 230 are included in a single module.

FIG. 2c shows an example control system 200 for a vehicle suspension system. Controller 240 is present as in FIGS. 2a-2b, which is connected by a communication channel 245 to anti-roll bar controllers 250, 260 configured to respectively control front and rear anti-roll actuators 272, 282. Also shown in FIG. 2c is a power converter module 410 and an electrical energy storage module 420. The power converter module 410 may comprise, for example, a bidirectional DCDC power converter. The electrical energy storage module 420 may comprise a supercapacitor energy storage module in some examples. The power converter module 410 may receive energy from a vehicle battery via power connection 412. The power converter module 410 may receive control inputs via communications bus 414. The electrical energy storage module 420 may receive energy from the power converter module 410 via power connection 422. The electrical energy storage module 420 may receive control inputs via communications bus 424. The electrical energy storage module 420 is also in electrical connection with the anti-roll bar controllers 250, 260 via respective connections 426, 428.

It will be appreciated that the control systems 200 of FIGS. 2a-2c may comprise one or more further connected controllers in some examples, and/or one or more further electrical or communication connections.

As stated above, the suspension system within a vehicle may comprise one or more subsystems. Each subsystem within the one or more subsystems may be configured to communicate directly with the other one or more subsystems, or, it may configured to communicate with the control system, which then communicates to the one or more subsystems. For example, the subsystems may communicate an operational condition with one another using a communication bus, as is discussed in FIGS. 2a-2c, above. In some examples, the communications between the one or more subsystems are routed through the controller 240 such that the controller 240 may track the operating condition of each of the one or more subsystems. The operating condition may therefore be labelled as a subsystem operating condition.

Each of the one or more subsystems may be configured for controlling a different component within the suspension system 300. For example, a first subsystem may be the anti-roll control system, discussed above in FIG. 2a-2c. As another example, a further subsystem may be one of a powertrain system of the vehicle and a roll stability control (RSC) system of the vehicle. The first subsystem, and the further subsystem, may each be, for example: an active roll control system of the vehicle suspension system (an active roll control system may be an electronic active roll control system, a mechatronic active roll control system, or a hydraulic active roll control system); an active damping system of the vehicle suspension system; an active springs system of the vehicle suspension system; a roll stability control system of the vehicle suspension system; a fully active suspension system; a directional stability control system; a rear wheel steering system; and an air suspension system. The suspension system may comprise a control system 100, 200 as discussed above. The control system 100, 200 may comprise one or more controllers 110, 240, as discussed in FIGS. 2a-2c, above.

As discussed above, the control system 100, 200 may be configured to determine if a first subsystem of the plurality of electrically connected subsystems has entered a fault state. In some examples, the fault state may be an operating state in which the first subsystem does not act as expected, due to a fault. That is, the fault state may be considered to be an abnormal operating state, different to the desired normal operating state. For example, a fault state in an electronic active roll control subsystem may be when a controller 110, 240 outputs a steady state torque demand signal, to the electronic active roll control subsystem, indicating that the electronic active roll control subsystem should produce a steady state torque of 1400 Nm at a front actuator. However, in response to receiving the torque demand signal, the electronic active roll control subsystem may output, at the front actuator, a steady state torque of 1000 Nm, thereby providing insufficient roll control and affecting the vehicle attributes such as vehicle handling and roll stability attributes. In this instance the discrepancy between the delivered and demanded torque may trip a diagnostic condition, causing the roll control subsystem to enter a fault state. That is, the fault state may be an operating state in which the subsystem is not able to deliver a primary function due to a fault being active in the system. In other words, the fault state may prevent a normal operating state and thus may lead to an undesirable state.

The control system 100, 200 may be configured to determine that the first subsystem is operating in the fault state by receiving a fault indicator from the first subsystem. The first subsystem may indicate that at least one component of the first subsystem has entered the fault state. In some examples, the control system 100, 200 may monitor the subsystems for a fault state. For example, if a subsystem is not responding in the way the control system 100, 200 expects, the control system 100, 200 may determine that the subsystem is in a fault state.

The control system 100, 200 may be configured to determine a compensatory operating state of a further subsystem of the plurality of connected subsystems, in dependence on determining that the first subsystem has entered the fault state. The further subsystem operating in the compensatory operating state, with the first subsystem operating in the fault state, may cause the vehicle suspension system to operate in a higher vehicle stability mode in comparison to the vehicle suspension system operating with the first subsystem operating in the fault state without the further subsystem operating in the compensatory operating state (i.e. to deliver either the same or an improved level of vehicle stability).

The control system 100, 200 may be configured to output, to the further subsystem, in dependence on determining the compensatory operating state, a compensatory operation signal to cause the further subsystem to operating in the compensatory operating state with the first subsystem operating in the fault state. The compensatory operating state may ensure that the further subsystem appropriately change its behaviour such that a functional safety target is met. As well as meeting the function safety target, the compensatory operating state may attempt to ensure that vehicle attribute degradation is reduced (for example ensuring a steering sensitivity is not changed by a large amount as a result of the first subsystem being in the fault state).

The control system 100, 200 may be configured to, in dependence on determining that the first subsystem has entered the fault state, output, to the first subsystem, a limited state request to cause the first subsystem to operate in a limited state, wherein the limited state is a limited functionality operating state relative to the full subsystem capability. For example, when entering the limited functionality operating state, the first subsystem may not respond to any demand signals. One or more further subsystems may restrict their response to any demand signals. That is, the first subsystem may no longer actuate because it has been determined to be operating abnormally. The further subsystem may no longer operate at full capability because it has been determined that the first subsystem is operating abnormally. Therefore a safety level of the vehicle may be maintained. That is, the limit state may be considered to be an allowable secure state, which may provide a degraded delivery of the faulty subsystem's and/or one or more further subsystems' intended primary and/or secondary function(s). For example, a front roll control module may detect a fault locally (for example control unit memory error). The entire active roll control system may respond to this by disabling the control for both front and rear axles. Once this is achieved, it may be considered that the active roll control system as a whole has entered one of its allowable system safe states. In response, the powertrain may be configured to limit torque requests during cornering.

In some examples, the compensatory operation signal comprises a request to the further subsystem to change at least one subsystem operating parameter of the further subsystem in dependence on a determine vehicle condition to cause the further subsystem to operate in the determine compensatory operating state. For example, the at least one subsystem operating parameter may relate to a setting of the further subsystem. For example, if the further subsystem was an RSC subsystem, the at least one subsystem operating parameter may relate to a tuning of the RSC subsystem. In another example, if the further subsystem was a powertrain subsystem, the at least one subsystem operating parameter may relate to a limit of a torque produced by the engine of the vehicle (i.e. the vehicle propulsion system). Other examples of subsystem operating parameters may be envisaged.

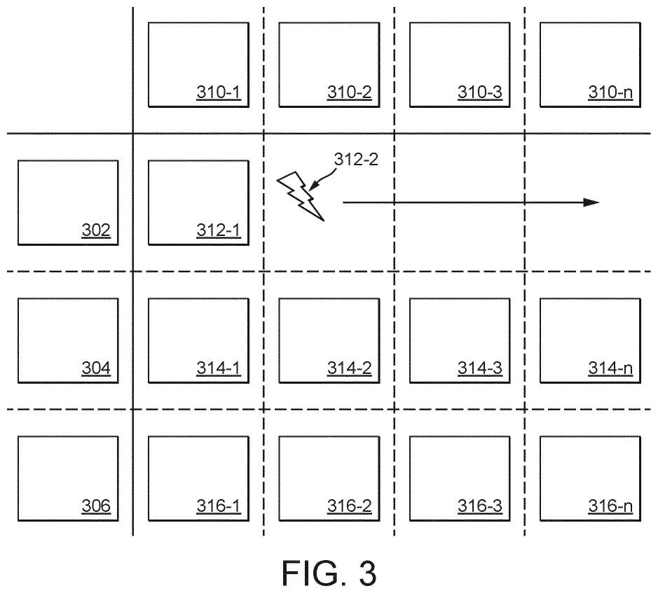

The control system 100, 200 may be configured to determine the compensatory operating state by identifying the at least one subsystem operating parameter in a look-up matrix as discussed in more detail in relation to FIG. 3. The look-up matrix may indicate, for at least one fault state/failure mode of the primary subsystem, a compensatory value for the at least one operating parameter for provision to the further subsystem to cause the further subsystem to operate in the compensatory operating state in dependence on the vehicle condition. In some examples, the control system 100, 200 may be configured to determine the compensatory operating state by identifying the at least one subsystem operating parameter using a nonlinear function such as a polynomial function. The nonlinear function may indicate for at least one fault state/failure mode of the primary subsystem, a compensatory value for the at least one operating parameter for provision to the further subsystem to cause the further subsystem to operate in the compensatory operating state in dependence on the vehicle condition. In some examples, the control system 100, 200 is configured to use the look-up matrix and/or the nonlinear function. For example, if the further subsystem was an RSC subsystem and the at least one subsystem operating parameter relates to a tuning of the RSC subsystem, the compensatory value for the at least one subsystem operating parameter may be one or more of a normal RSC tune, an intermediate RSC tune, and an aggressive RSC tune. In another example, if the further subsystem was a powertrain subsystem, and the at least one subsystem operating parameter relates a limit of a torque produced by the engine of the vehicle (or other vehicle propulsion systems in examples in which powertrain systems other than engines are used), the compensatory value for the at least one subsystem operating parameter may be one or more of: setting no limit on engine/powertrain torque, setting a limit on the maximum engine/powertrain torque to a medium level; and setting a limit on the maximum engine/powertrain torque to a low level. That is to say, the compensatory value relates to how the at least one subsystem operating parameter is set such that the functional safety target may be met.

As stated above, the compensatory value and therefore the at least one subsystem operating parameter are determined/changed in dependence on a vehicle condition. In some examples, the vehicle condition may comprise at least one of: a determined driving condition, a user-set driving mode, and an operating limit setting. That is, the vehicle condition may relate to a current use case of the vehicle.

The determined driving condition may indicate a current interaction between the vehicle and a driving surface. The determined driving condition may relate to at least one of whether the vehicle is performing a braking manoeuvre; whether the vehicle is performing an accelerating manoeuvre; whether the vehicle is moving at substantially constant speed; and whether the vehicle is performing a cornering manoeuvre. For example, the determined driving condition may be that the vehicle is performing an accelerating manoeuvre while the vehicle is simultaneously performing a cornering manoeuvre and determine the compensatory value and the at least one subsystem operating parameter in dependence with the determined driving condition. In some examples the driving condition may further relate to at least one of a vehicle pitch angle, a vehicle pitch angle change rate, a vehicle yaw angle, and a vehicle yaw angle change rate.

The control system 100, 200 may be configured to, when determining the driving condition, receive at least one detected signal. In some examples, the at least one detected signal may be from at least one sensor of the vehicle. For example, the at least one sensor may comprise: a respective suspension height sensor of the vehicle suspension; a respective motor position sensor for the anti-roll bar actuators 272, 282; a respective hub acceleration sensor of the vehicle; and a respective torque sensor for the anti-roll bar actuators 272, 282. The control system 100, 200, may be configured to input the received detected input signals into a model to determine the driving condition. In some examples, the model may map one or more of a vehicle steering angle, a vehicle lateral acceleration, a vehicle speed, a vehicle roll rate, a torque rate of change, and a vehicle longitudinal acceleration, to a physical state of the vehicle (i.e. the driving condition). As stated above, the determined driving condition may be at least one of whether the vehicle is performing a braking manoeuvre; whether the vehicle is performing an accelerating manoeuvre, whether the vehicle is moving at substantially constant speed, and whether the vehicle is performing a cornering manoeuvre. That is, the model may map one or more of a vehicle steering angle, a vehicle lateral acceleration, a vehicle speed, a vehicle roll rate, a torque rate of change, and a vehicle longitudinal acceleration, to a at least one of whether the vehicle is performing a braking manoeuvre; whether the vehicle is performing an accelerating manoeuvre, and whether the vehicle is performing a cornering manoeuvre, and optionally at least one of the vehicle pitch and the vehicle yaw.

The user-set driving mode may indicate a driving characteristic that is to be attempted to be preserved when the first subsystem enters the fault state. That is, the user-set driving mode may relate to an attribute (particular characteristic) for the vehicle such as: sport, comfort, and/or eco. In other words, the user-set driving mode may be indicative of how one or more subsystems may contribute to the delivery of a vehicle level attribute/characteristic. For example, the user-set driving mode may be set to a sport mode and therefore, the compensatory value and the at least one subsystem operating parameter may be determined from the look-up table such that a sport mode characteristic is maintained (for example responsive steering and firm suspension).

The operating limit setting may be indicative of a limit value (i.e. a minimum value and/or a maximum value) of one or more subsystem operating parameters. For example, the operating limit setting may indicate the maximum value that the one or more operating parameters are rated to. For example, if the RSC subsystem enters a fault state and the vehicle condition is a cornering manoeuvre, the minimum damping limit requested of the damping system may be raised. By raising the minimum damping limit, the vehicle stability is increased; further the loads within the vehicle suspension system are limited such that the further subsystem in the operating in the compensatory state operates within its operating limits and therefore is not damaged when operating in the compensatory operating state.

In some examples, the vehicle condition may further comprise a driving surface type on which the vehicle is located. For example: on-road or off road. As an example, on-road may be, in the UK, a motorway, an A road, a B road, a race track, and/or, a ford. Other geographic locations may have different road classifications which provide different driving surface types. As an example, off-road may be grass, gravel, snow, sand and/or rocks. For example, the control system may determine that the vehicle is located on a race track when encountering a fault state for an electronic active roll control subsystem. In response, the control system 100, 200 may determine the at least one subsystem operating window for a suspension damping subsystem to be more firm in response.

In some examples, the control system 100, 200 may be configured to periodically receive a second vehicle condition. In some examples, the control system 100, 200 may be configured to monitor the vehicle condition to determine the second vehicle condition. That is, the control system 100, 200 may be configured to continuously monitor one or more of the determined driving condition, user-set driving mode, and the operating limit setting. That is, a single signal indicative of the vehicle condition is monitored, from which the second vehicle condition is received. The control system 100, 200 may be configured to compare the vehicle condition to the second vehicle condition. For example, control system 100, 200 may determine that the vehicle condition was that the vehicle was performing a cornering manoeuvre, using a user-set sports mode driving mode, with a 2000 Nm operating limit setting for the further subsystem and then determine the second vehicle condition is that the vehicle is not performing a cornering manoeuvre, in the user-set sports mode driving mode, with a 2000 Nm operating limit setting for the further subsystem. Therefore, in the above example, the control system 100, 200 may determine that the vehicle condition has changed and the vehicle is no longer performing a cornering manoeuvre. In response to the vehicle condition being different to the second vehicle condition, the control system 100, 200 may be configured to determine a second compensatory operating state in dependence on the second vehicle condition. In dependence on determining the second compensatory signal, the control system 100, 200, may be configured to output, to the further subsystem, a second compensatory operation signal to cause the further subsystem to operate in the second compensatory operating state with the first subsystem operating in the fault state.

In some examples, the control system 100, 200 may be configured to determine the second compensatory operating state by identifying a second at least one subsystem operating parameter in the look-up matrix. That is to say, the control system 100, 200 is configured to adaptively change the compensatory operating state based on a current use case, such that a functional safety target is met, and vehicle attribute degradation is reduced.

In some examples, the control system 100, 200 may be configured to cause the further subsystem to operate in the compensatory operating state by causing the further subsystem to gradually operate in the compensatory operating state over a period of time. That is, the control system 100, 200 may be configured to blend operation from the limited functionality state to the compensatory operating state. This may, for example, prevent any abrupt changes in the vehicle attributes which may be felt by a user. The control system 100, 200, may be configured to cause the further subsystem to operate in the second compensatory operating state by causing the further subsystem to gradually operate in the second compensatory operating state, from the compensatory operating state. The control system 100, 200, may be configured to cause the further subsystem to operate in any compensatory operating state by causing the further subsystem to gradually operate in the compensatory operating state.

As stated above, the further subsystem operating in the compensatory operating state, with the first subsystem operating in the fault state, causes the vehicle suspension system to operate in a higher vehicle stability mode in comparison to the vehicle suspension system operating with the first subsystem operating in the fault state without the further subsystem operating in the compensatory operating state. The higher vehicle stability mode (i.e. the improved vehicle stability level) may be achieved by one or more of an operation mode of the vehicle suspension system configured to reduce the magnitude of impacts (i.e. loads) on one or more other systems within the vehicle; an operation mode configured to maintain a current driving attribute of the vehicle; and an operation mode configured to limit operational regions of the vehicle. For example, the operation mode configured to reduce the magnitude of impacts/loads on one or more other systems may be configured such that the maximum impact/load a system can withstand is not achieved as a result of the higher stability mode/level. As another example, the operation mode configured to maintain a current driving attribute may be configured such that a driving attribute in place before the first subsystem entered the fault state is maintained. For example, if the vehicle was in a sport mode before the fault state, the vehicle attributes associated with the sport mode are maintained by the higher stability mode. As another example, the operation mode configured to limit operation regions of the vehicle may be configured such that limits are placed on the acceleration and/or speed of the vehicle, while in the higher stability mode. In some examples, the control system may be configured to maintain the fault state of the first subsystem and the compensatory operating state of the further subsystem until the vehicle performs a power-down process.

FIG. 3 shows a schematic example of how the compensatory operating state may change in dependence on the determined driving condition. FIG. 3 represents the suspension system comprising a plurality of subsystems 302, 304, 306. For example the plurality of subsystems may comprise an electronic active roll control subsystem 302, a powertrain subsystem 304, and a roll stability control subsystem 306. Other examples may comprise at least two subsystems of the same or other types.

The control system 100, 200 may determine that the vehicle subsystems 302, 304, 306 are operating in a normal state 312-1, 314-1, 316-1 for the vehicle use case 310-1. As such, the control system 100, 200 may determine that none of the subsystems 302, 304, 306 are in a fault state and determine that the compensatory value for the at least one subsystem operating parameter is not required. For example, an electronic active roll control subsystem 302 may be in a first operating mode 312-1; a powertrain subsystem 304 may be in an operating mode 314-1 wherein there is no limitation to an engine torque; an RSC subsystem 306 may be in an operating mode 316-1 wherein the RSC has a normal tune. The control system 100, 200 may determine that a first subsystem 302 enters a fault state 312-2. For example, the control system 100, 200 may determine that at least one component within the electronic active roll control subsystem 302 is behaving in an abnormal operating state i.e. it cannot deliver its primary function as intended.

The control system 100, 200 may determine the vehicle condition 310-2 of the vehicle based on at least one of the a determined driving condition, a user-set driving mode, and an operating limit setting, as described above. For example, the control system 100, 200 may determine the vehicle condition to be that the vehicle is cornering, on-road, in an eco-driving mode. In response the control system may determine a compensatory value for the at least one subsystem operating parameter (i.e. the compensatory operating states) 314-2, 316-2 for the further subsystems 304, 306. For example, the control system 100, 200 may determine that the powertrain subsystem 304 should operate with a limit on the maximum engine/powertrain torque; and that the RSC subsystem 306 should operate in a normal RSC tune. The control system 100, 200 may be configured to cause the further subsystems 304, 306 to gradually operate in the compensatory operating states 314-2, 316-2, from respective operating states 314-1, 316-1, over a period of time.

The control system 100, 200 may receive a second vehicle condition 310-3. The control system 100, 200 may determine that the vehicle condition 310-2 is different to the second vehicle condition 310-3 while the first subsystem 302 is in the fault state 312-2. For example, the control system 100, 200 may determine the vehicle condition to be that the vehicle is not cornering, on-road, in an eco-driving mode. In response the control system 100, 200 may determine a second compensatory value for the at least one subsystem operating parameter (i.e. a second compensatory operating states) 314-3, 316-3 for the further subsystems 304, 306. For example, the control system 100, 200 may determine that the powertrain subsystem 304 should operate without a limit on the maximum engine/powertrain torque; and that the RSC subsystem 306 should operate in a normal RSC tune. The control system 100, 200 may be configured to cause the further subsystems 304, 306 to gradually operate in the second compensatory operating states 314-3, 316-3, from the compensatory states 314-2, 316-2, over a period of time.

That is, as the fault state 312-2 for the first subsystem 302 persists, the control system 100, 200 may periodically receive and/or monitor the vehicle condition 310-n to determine whether the nth compensatory operating state 314-n, 316-n of the further subsystems 304,306 may be adaptively changed to the current, nth vehicle condition 310-n.

In some examples, the control system 100, 200 may be configured to determine that the first subsystem has completed operating in the fault state in response to determining that the fault condition is no longer present. For example, the control system 100, 200 may determine a diagnostic check to determine whether the response from the first subsystem is not abnormal. For example, the control system 100, 200, or the first subsystem may check that an output of a subsystem is as expected when the subsystem receives a demand signal. That is, the diagnostic check may determine that the fault condition is not present and that the first subsystem can deliver its primary and/or second function(s). In some examples, in dependence on determining that the first subsystem has completed operating in the fault state, the control system 100, 200 may be configured to output a normal operation indicator to the further subsystem. The normal operation indicator may be configured to cause the further subsystem to operate in the operating mode based on the current vehicle condition, using the look-up matrix. Such a process may be considered to be a “healing” process of continuing operation of the vehicle with the first subsystem in a fault state until the first subsystem can again operate normally.

In other examples, the control system 100, 200 may be configured to maintain the fault state of the first subsystem until the vehicle performs a power-down process. That is, once a subsystem enters into a fault state during a journey, the subsystem will stay in the fault state until the car stops and the engine is turned off. The control system 100, 200, may determine that a journey has finished when the ignition key is removed from the vehicle. This may help prevent the continuation of a fault state for the remainder of a drive cycle (from power-up of the vehicle to power-down of the vehicle).

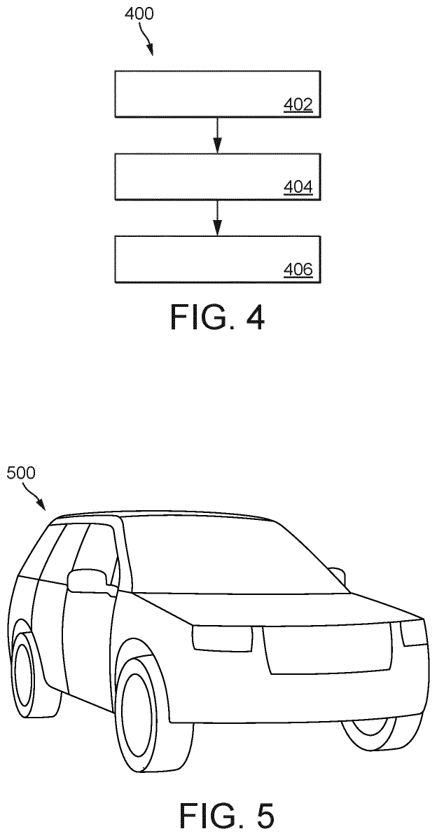

FIG. 4 show a method 400 of a control system 100 for a vehicle suspension system of vehicle, such as the vehicle 500 in FIG. 5. The control system as discussed above comprises one or more controllers and the vehicle suspension system comprises an actuator.

The method 400 may be performed by the control system 100 illustrated in FIG. 1. In particular, the memory 130 may comprise computer-readable instructions which, when executed by the processor 120, perform the method 400 according to an embodiment of the invention. The blocks illustrated in FIG. 4 may represent steps in a method 400 and/or sections of code in a computer program configured to control the control system as described above to perform the method steps. The illustration of a particular order to the blocks does not necessarily imply that there is a required or preferred order for the blocks and the order and arrangement of the block may be varied. Furthermore, it may be possible for some steps to be omitted or added in other examples. Therefore, this disclosure also includes computer software that, when executed, is configured to perform any method disclosed herein, such as that illustrated in FIG. 4. Optionally the computer software is stored on a computer readable medium, and may be tangibly stored.

The method 400 comprises: determining 402 if a first subsystem of a plurality of connected subsystems of a vehicle suspension system has entered a fault state, wherein the fault state is an abnormal operating state; in dependence on determining that the first subsystem has entered the fault state, determining 404 a compensatory operating state of a further subsystem of the plurality of connected subsystems, wherein the further subsystem operating in the compensatory operating state, with the first subsystem operating in the fault state, causes the vehicle suspension system to operate in a high vehicle stability mode in comparison to the vehicle suspension system operating with the first subsystem operating in the fault state without the further subsystem operating in the compensatory operating state; and outputting 406, to the further subsystem, a compensatory operation signal to cause the further subsystem to operate in the compensatory operating state with the first subsystem operating in the fault state.

FIG. 5 illustrates a vehicle 500 according to an embodiment of the invention. The vehicle 500 in the present embodiment is an automobile, such as a wheeled vehicle, but it will be understood that the control system 100 and active suspension system may be used in other types of vehicle.

It will be appreciated that various changes and modifications can be made to the examples disclosed herein without departing from the scope of the present application as defined by the appended claims.

As used here ‘module’ refers to a unit or apparatus that excludes certain parts/components that would be added by an end manufacturer or a user.

As used here, ‘connected’ means ‘electrically interconnected’ and/or “mechanically interconnected” either directly or indirectly. Electrical interconnection does not have to be galvanic. Where the control system is concerned, connected means operably coupled to the extent that messages are transmitted and received via the appropriate communication means. The terms “output” and “transmit” may be used interchangeably in terms of a signal, indicator, or data, for example, being provided from one entity to another entity.

Although examples have been described in the preceding paragraphs with reference to various examples, it should be appreciated that modifications to the examples given can be made without departing from the scope of the invention as set out in the appended claims. Features described in the preceding description may be used in combinations other than the combinations explicitly described. Although functions have been described with reference to certain features, those functions may be performable by other features whether described or not. Although features have been described with reference to certain embodiments, those features may also be present in other embodiments whether described or not. Whilst endeavouring in the foregoing specification to draw attention to those features believed to be of particular importance it should be understood that the Applicant claims protection in respect of any patentable feature or combination of features hereinbefore referred to and/or shown in the drawings whether or not particular emphasis has been placed thereon.

1-15. (canceled)

6. A control system for a vehicle suspension system in a vehicle, the vehicle suspension system comprising a plurality of connected subsystems, the control system comprising one or more controllers, the control system configured to:
determine if a first subsystem of the plurality of connected subsystems has entered a fault state, wherein the fault state is an abnormal operating state;
determine a compensatory operating state of a further subsystem of the plurality of connected subsystems in dependence on determining that the first subsystem has entered the fault state, wherein the further subsystem operating in the compensatory operating state, with the first subsystem operating in the fault state, causes the vehicle suspension system to operate in a higher vehicle stability mode in comparison to the vehicle suspension system operating with the first subsystem operating in the fault state without the further subsystem operating in the compensatory operating state; and
output, to the further subsystem, in dependence on determining the compensatory operating state, a compensatory operation signal to cause the further subsystem to operate in the compensatory operating state with the first subsystem operating in the fault state.

17. The control system of claim 16, wherein in dependence on determining that the first subsystem has entered the fault state, the control system is configured to:
output, to the first subsystem, a limited state request to cause the first subsystem to operate in a limited state, wherein the limited state is a limited functionality operating state.

18. The control system of claim 16, wherein the compensatory operation signal comprises a request to the further subsystem to change at least one subsystem operating parameter of the further subsystem in dependence on a determined vehicle condition to cause the further subsystem to operate in the determined compensatory operating state.

19. The control system of claim 18, wherein the control system is configured to determine the compensatory operating state by identifying the at least one subsystem operating parameter in a look-up matrix;
wherein the look-up matrix indicates, for at least one fault state of the primary subsystem, a compensatory value for the at least one subsystem operating parameter for provision to the further subsystem to cause the further subsystem to operate in the compensatory operating state in dependence on the vehicle condition.

20. The control system of claim 18, wherein the vehicle condition comprises at least one of:
a determined driving condition, indicative of a current interaction between the vehicle and a driving surface;
a user-set driving mode, indicative of one or more subsystem operating parameter to be prioritized; and
an operating limit setting, indicative of a limit value of the one or more subsystem operating parameters.

21. The control system of claim 18, wherein the control system is configured to:
periodically receive a second vehicle condition;
compare the vehicle condition to the second vehicle condition;
in response to the vehicle condition being different to the second vehicle condition, determine a second compensatory operating state in dependence on the second vehicle condition; and
output, to the further subsystem, a second compensatory operation signal to cause the further subsystem to operate in the second compensatory operating state with the first subsystem operating in the fault state.

22. The control system of claim 20, wherein the control system is configured to, when determining the driving condition:
receive at least one detected signal, from at least one sensor of the vehicle; and
input the received detected signal into a model to determine the driving condition, wherein the determined driving condition is at least one of whether the vehicle is performing a braking maneuver; whether the vehicle is performing an accelerating maneuver; whether the vehicle is moving at substantially constant speed; and whether the vehicle is performing a cornering maneuver.

23. The control system of claim 16, wherein the higher vehicle stability mode is one or more of:
an operation mode of the vehicle suspension system configured to reduce the magnitude of impacts on one or more other systems within the vehicle;
an operation mode configured to maintain a current driving attribute of the vehicle; and
an operation mode configured to limit operational regions of the vehicle.

24. The control system of claim 16, wherein the control system is configured to cause the further subsystem to operate in a compensatory operating state by causing the further subsystem to gradually operate in the compensatory operating state over a period of time.

25. The control system of claim 16, wherein the control system is configured to: maintain the fault state of the first subsystem and the compensatory operating state of the further subsystem until the vehicle performs a power-down process.

26. The control system of claim 16, wherein the control system is configured to determine that the first subsystem is operating in a fault state by receiving a fault indicator from the first subsystem, the fault indicator indicating that at least one component of the first subsystem has entered the fault state.

27. The control system of claim 16, wherein one or more of the first subsystem and the further subsystem are one or more of:
an active roll control system of the vehicle suspension system;
an active damping system of the vehicle suspension system;
an active springs system of the vehicle suspension system;
a roll stability control system of the vehicle suspension system;
a fully active suspension system;
a directional stability control system;
a rear wheel steering system; and
an air suspension system.

28. A vehicle comprising a control system according to claim 16.

29. A method, comprising:
determining if a first subsystem of a plurality of connected subsystems of a vehicle suspension system has entered a fault state, wherein the fault state is an abnormal operating state;
in dependence on determining that the first subsystem has entered the fault state, determining a compensatory operating state of a further subsystem of the plurality of connected subsystems, wherein the further subsystem operating in the compensatory operating state, with the first subsystem operating in the fault state, causes the vehicle suspension system to operate in a high vehicle stability mode in comparison to the vehicle suspension system operating with the first subsystem operating in the fault state without the further subsystem operating in the compensatory operating state; and
outputting, to the further subsystem, a compensatory operation signal to cause the further subsystem to operate in the compensatory operating state with the first subsystem operating in the fault state.

30. Computer readable instructions arranged to perform the method according to claim 29.
